(19) United States
(12) Patent Application Publication
(10) Pub. No.: US 2009/0031599 A1
(43) Pub. Date: Feb. 5, 2009

(54) Display device

(76) Inventors: Konomu Ogikubo, Tokyo (JP); Kazuhiko Sugiyama, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 12/155,816

(22) Filed: Jun. 10, 2008

(30) Foreign Application Priority Data
Aug. 1, 2007 (JP) 2007-200875
Dec. 26, 2007 (JP) 2007-334629

(51) Int. Cl. G09F 19/00

(52) U.S. Cl. 40/603

(57) ABSTRACT

The invention presents a roll-sheet type display device for use at a booth or sales counter of small retail shop, window of retail shop, or outer wall of a building, being capable of displaying very easily without requiring huge installation work, and exchanging advertising and decorating means easily and at low cost.

A display device 1 has a display sheet 14 showing printed advertising or decorating display object rolled on a roll 13, for forming a display object by unrolling and stretching by the roll 13, in which one part of the display sheet 14 is detachably attached to the roll 13.

### BACKGROUND OF THE INVENTION

The present invention relates to a roll-screen type display device to be installed at a booth or sales counter of a closed shop, window of retail shop, or outer wall of a building, being capable of attaching or detaching easily a display sheet such as advertising object, and exchanging the display object easily and safely.

### PRIOR ART

Conventionally, for decorating the shop outer circumference with adverting object, various methods have been proposed, including a method of direct painting on the shutter or outer all of the building, a method of adhering a marking film printing commercial message to the shutter by using an adhesive, and shutter-display devices for combining the shutter and the display sheet as disclosed in patent document 1 and patent document 2. The shutter-display devices disclosed in patent document 1 and patent document 2 are devices designed to position a display sheet forming a display object on a conventional shutter surface, and take out the display sheet and the shutter in interlock action.

On the other hand, a large-sized roll-screen type display device to be installed on the outer wall of a building is disclosed, for example, in patent document 3, which shows a building outer structure. The building outer structure disclosed in patent document 3 is a very huge structure consisting of a curtain wall, a roll screen provided at the lateral side, and a blind provided at the rear side.
Patent document 1: Japanese Published Unexamined Patent Application No. H-1-178694
Patent document 2: Japanese Published Unexamined Patent Application No. 2006-63603
Patent document 3: Japanese Published Unexamined Patent Application No. 2003-253978
Patent document 4: Japanese Published Unexamined Patent Application No. H-7-331972

### SUMMARY OF THE INVENTION

According to the shutter-display devices disclosed in patent document 1 and patent document 2, when the shutter or building outer wall is directly painted, as compared with the method of adhering a printed advertising marking film to the shutter by using an adhesive, the advertising object can be installed easily and inexpensively, and it is relatively easy to change the advertising and decorating contents. However, a thick structure is needed for interlocking the display sheet and the shutter, it is not suited to a railway station kiosk or small shop. Above all, it cannot be installed in a shop not having the shutter. Besides, since the advertising cycles are shorter recently, it is necessary to exchange the display contents frequently, and in order to reduce the running cost, it is being demanded to exchange the display object more easily and inexpensively.

Further, the building outer wall structure in patent document 3 requires a huge modification work for the building in order to present a large display, and the installation cost and running cost are higher, and frequent change of advertising and decorating contents was difficult and dangerous.

Meanwhile, as disclosed in patent document 4, various concealing roll screens are proposed, but the concealing screen must be permanent fixed, and there is no concept of frequent change of screen, and the screen is formed integrally with the roll or permanently fixed to the roll, and it is not designed to exchange the screen.

The invention is intended to present a display device for use at a booth or sales counter of small retail shop, window of retail shop, or outer wall of a building, being capable of displaying very easily without requiring huge installation work, and exchanging only display sheets printing advertising, decorating and other object easily and at low cost.

It is also an object of the invention to present a display device capable of exchanging the display sheet easily by any person without requiring stepladder or the like even in a wide space or high ceiling such as display window of automobile sales shop.

It is another object of the invention to present a display device capable of displaying the advertising and decorative display object in a flat state, and preventing fluttering of display sheet by wind when the display object is installed outdoors.

### BRIEF DESCRIPTION OF THE DRAWINGS

FIG. 1 is a front view showing a first preferred embodiment of the invention.

FIG. 2 is a side view showing a display device shown in FIG. 1.

FIG. 3 is a perspective exploded view showing the display device shown in FIG. 1.

FIG. 4 is a front view showing a first preferred embodiment of the invention.

FIG. 5 is a side view showing a display device shown in FIG. 4.

FIG. 6 is a perspective exploded view showing the display device shown in FIG. 4.

FIG. 7 is a perspective exploded view showing a third preferred embodiment of the invention.

FIG. 8 is a perspective view showing an intermediate mounting process showing the display device shown in FIG. 7.

### DESCRIPTION OF THE PREFERRED EMBODIMENTS

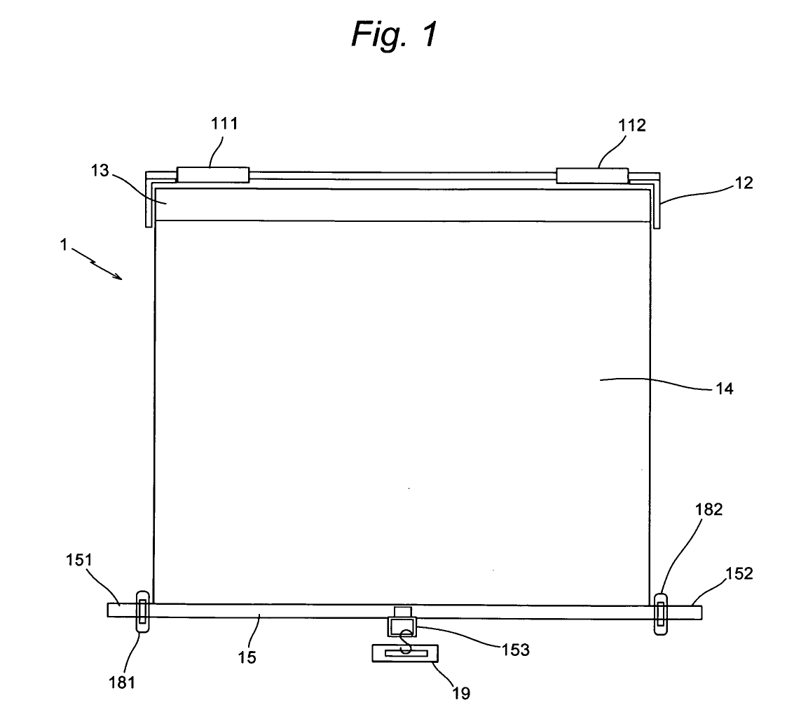

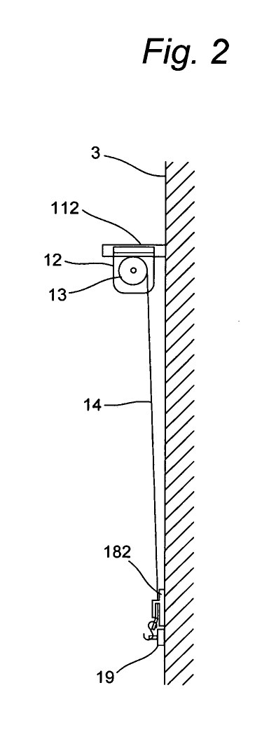

FIGS. 1 to 3 show a first preferred embodiment of the display device of the invention, and this is the display device mainly used to display before the shutter of a closed shop, sales counter or small retail shop.

A display device 1 has a display sheet 14 showing printed advertising or decorating display object rolled on a roll 13, and display object is formed by unrolling and stretching by the roll 13, and one part of the display sheet 14 is detachably attached to the roll 13, and other part is detachably attached to a support member 15 for other part of the display sheet.

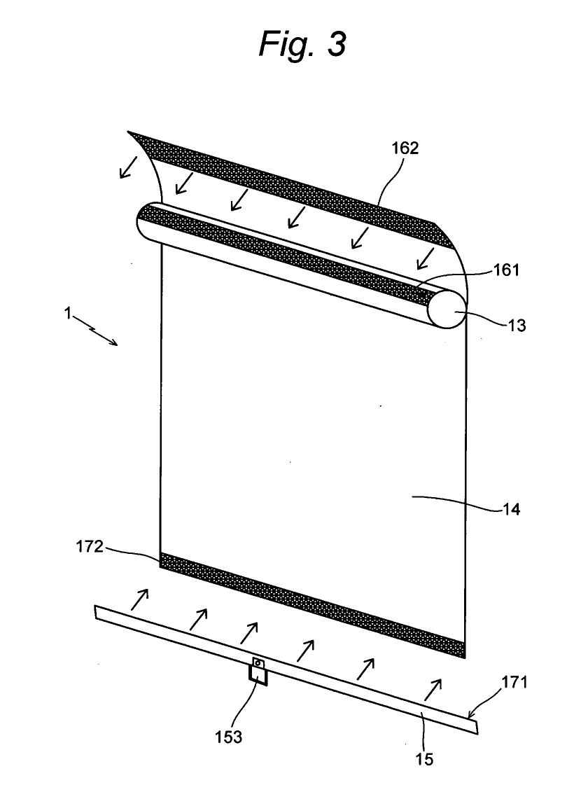

The roll 13 is rotatably supported on a bracket 12 installed in base adapters 111, 112 provided at wall 3 or ceiling of the place of installation, and it has an elevating function of taking up and letting off the display sheet 14 by a thrusting force of a take-up spring not shown, so that the display sheet 14 may be taken up or stretched freely. In the display device 1, as indicated by arrow in FIG. 3, the display surface side of the display sheet 14 is supported so as to rotate to roll into the side of the roll 13. The rotating mechanism of the roll 13 is not particularly specified, and the display sheet 14 may be taken up by rotating the roll by driving by chain or rope, or it may be driven electrically. Further, as shown in FIG. 3, a surface fastener 161 is fixed in the axial direction of the roll 13, and from the fixing point of this surface fastener, the display sheet 14 can be taken out.

The support member 15 for other part of the display sheet is formed as a flat bar, and the display sheet 14 is adhered in the axial direction, and the display sheet 14 is stretched and supported flatly, and when letting off the display sheet 14, it functions as stopping member for stopping and fixing to the stopping claw of the support member for other part provided on the wall, and when taking up the display sheet 14, it functions as take-up stopper. In the axial direction of the support member 15 for other part of the display sheet at the side abutting against the display sheet 14, a surface fastener 171 as attaching and detaching means, so that the display sheet 14 may be peeled. Further, the support member 15 for other part of the display sheet is formed longer than the width of the display sheet 14 to be stretched, and both ends 151, 152 of the support member for other part of the display sheet are stopped by stopping claws 181, 182 of the support member for other part of the display sheet fixed to the wall 3 of the place of installation when the display sheet 14 is stretched, so that the display sheet 14 may be stretched and held in this state. Nearly in the middle of axial direction of the support member 15 for other part of the display sheet, a hook-like display fixing member 153 may be disposed for reinforcing the stretched state by fixing to the display sheet fixing and stopping member 19 fixed to the wall 3 of the place of installation when stretching the display sheet 14.

On the other hand, at one edge of the display sheet 14 positioned at the roll side, a surface fastener 162 is fixed as attaching and detaching means. By fixing this surface fastener 162 to or departing from the surface fastener 161, the display sheet 14 is freely attached to or detached from the roll. At other edge of the display sheet 14 positioned at the side of the support member for other part of the display sheet, a surface fastener 172 is fixed as attaching and detaching means. By fixing this surface fastener 172 to or departing from the surface fastener 171, the display sheet 14 is freely attached to or detached from the support member 15 for other part of the display sheet.

This display device 1 is installed along the shutter of shop or sales counter, or directly on the counter, and the display sheet 14 is taken up while the shop is open, and the display sheet 14 is rolled up by the roll 13 when the shop is closed, so that the display object can be easily demonstrated.

When exchanging the display sheet 14, by rotating the roll 13, the existing display sheet 14 is taken out, and the surface fastener fixing part of the display sheet 14 is drawn out, and the surface fasteners are peeled off from each other, so that the display sheet 14 may be easily detached from the roll 13 and the support member 15 for other part of the display sheet. When presenting a new display sheet 14, the surface fastener 162 of the display sheet 14 and the surface fastener 161 of the roll are bonded to each other, and the surface fastener 172 is abutted against to contact with the surface fastener 171 of the support member 15 for other part of the display sheet, and the display sheet 14 can be stretched.

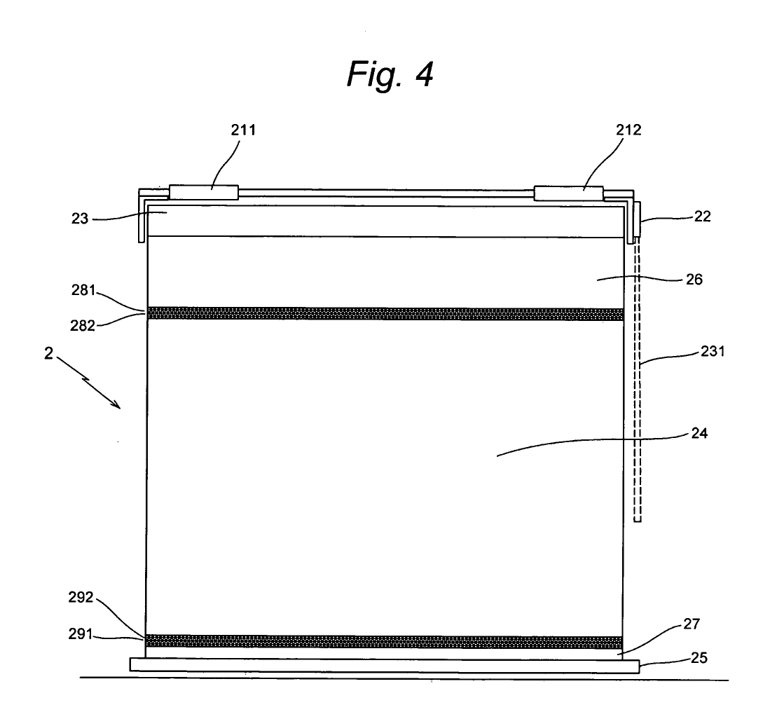

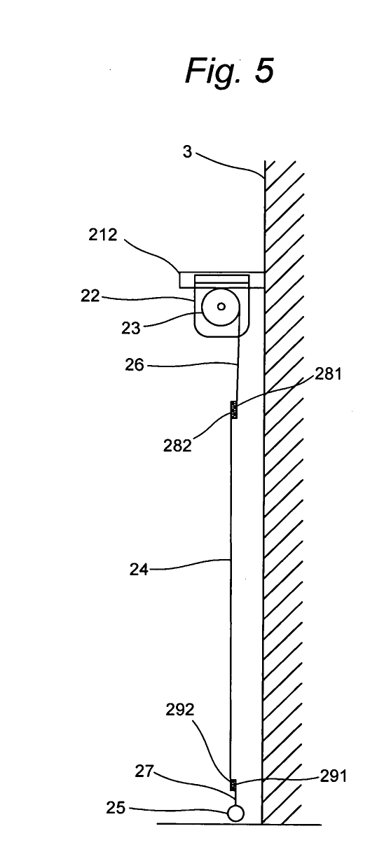

FIGS. 4 to 6 show a second preferred embodiment of the display device of the invention, and it is a display device to be installed in a place of a large scale, such as large window of an automobile sales shop or the outer wall of a building.

A display device 2 has a display sheet 24 showing printed advertising or decorating display object rolled on a roll 23, and display object is formed by unrolling and stretching by the roll 23, and the roll 23 is provided with an adjusting sheet 26 for taking up and letting off freely according to a desired length, and one part of the display sheet 24 is attached or detached freely to the adjusting sheet 26 provided in the roll 23, and other part is attached or detached freely to an adjusting sheet 27 provided in a support member 25 for other part of the display sheet.

The roll 23 is rotatably supported on a bracket 22 installed in base adapters 211, 212. The roll 23 has an elevating function of taking up and letting off the adjusting sheet 26 along with rotation of a chain by a gear not shown to be engaged with chain 231, and is designed to stretch and hold the display sheet 24 and take it up freely. The rotating mechanism of the roll 23 is not particularly specified, and it may be driven electrically, or the display sheet 24 may be taken up by a thrusting force of a take-up spring.

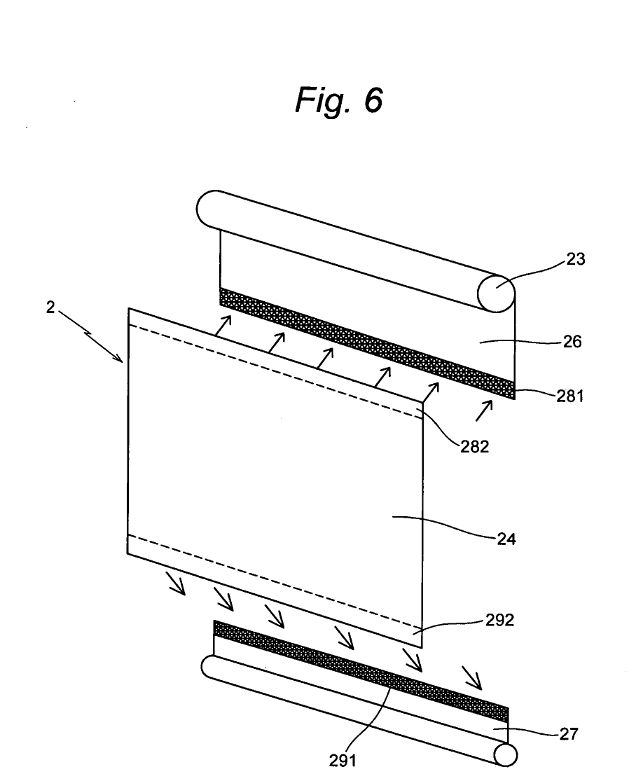

Further, as shown in FIG. 4 and FIG. 6, in the axial direction of the roll 23, for adjusting the height of the display sheet 24, the adjusting sheet 26 is fixed, which is made of a sheet member capable of holding the display sheet 24, in a state free to take up and let off depending on a desired length. The length of the adjusting sheet 26 is desired to be specifically about 0 to 1.5 meters from the floor, that is, within the reach of hand of the person exchanging the display sheet 23 when stretched. At the edge of the adjusting sheet 26 opposite to the fixed part of the roll 23, a surface faster 281 is fixed as display sheet attaching and detaching means for attaching or detaching the display sheet 24.

The support member 25 for other part of the display sheet is a cylindrical bar long in the axial direction, and other part of the display sheet 24 is adhered in the axial direction, and the display sheet 24 is stretched and supported flatly by the weight of the support member of other part. In the axial direction of the support member 25 for other part of the display sheet, an adjusting sheet 27 of a sheet member is fixed, and a surface fastener 291 as attaching and detaching means is fixed at the edge opposite to the edge fixed to the support member 25 for other part of the display sheet.

On the other hand, at one edge of the display sheet 24 positioned at the roll side, a surface fastener 282 is fixed as attaching and detaching means. By fixing this surface fastener 282 to or departing from the surface fastener 281, the display sheet 24 is freely attached to or detached from the adjusting sheet 26, and is held on the roll 23 by means of the adjusting sheet 26. At other edge of the display sheet 24 positioned at the side of the support member for other part of the display sheet, a surface fastener 292 is fixed as attaching and detaching means. By fixing this surface fastener 292 to or departing from the surface fastener 291, the display sheet 24 is freely attached to or detached from the adjusting sheet 27 and is supported on the adjusting sheet 27.

This display device 2 is installed inside of a large window of an automobile sales shop or along the outer wall of a building, and usually the display sheet 24 is presented at a desire height by adjusting the projecting length of the adjusting sheet 26.

When exchanging the display sheet 24, by rotating the roll 23, the adjusting sheet 26 is lowered nearly to the floor. In this state, the surface fastener fixing part of the existing display sheet 24 is drawn out, and the surface fastener is detached, so that the display sheet 24 may be easily detached from adjusting sheet fixed on the roll and the base sheet 27 fixed to the support member 25 for other part of the display sheet. When presenting a new display sheet 24, the adjusting sheet 26 is brought closer to the person handling the display sheet, and the surface fastener 282 and the surface fastener 281 are bonded to each other, and the surface fastener 292 and the surface fastener 291 are bonded to each other, and the adjusting roll 26 is taken up on the roll 23 and the display sheet 24 can be stretched.

Meanwhile, in the display devices 1 and 2 shown in the preferred embodiments, the display sheet attaching and detaching means is preferred to be formed as a band-shaped surface fastener because it is easy to attach or detach, and peeling of display sheet can be prevented securely, but the attaching and detaching means is not particularly specified, and any member may be used as far as it is easy to attach or detach, and peeling can be prevented securely, and any display sheet attaching and detaching means made of snap member or silicon member to be engaged with convex portions and concave portions may be used.

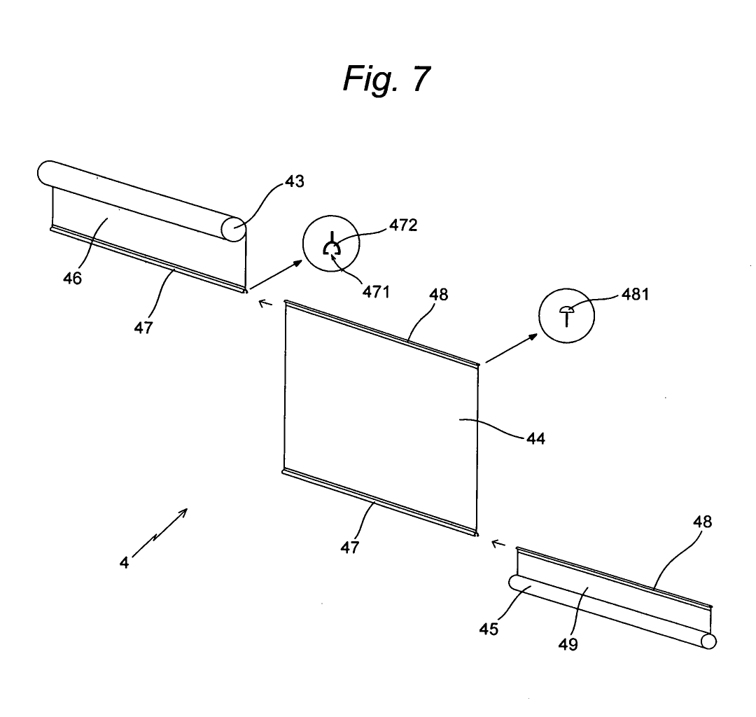

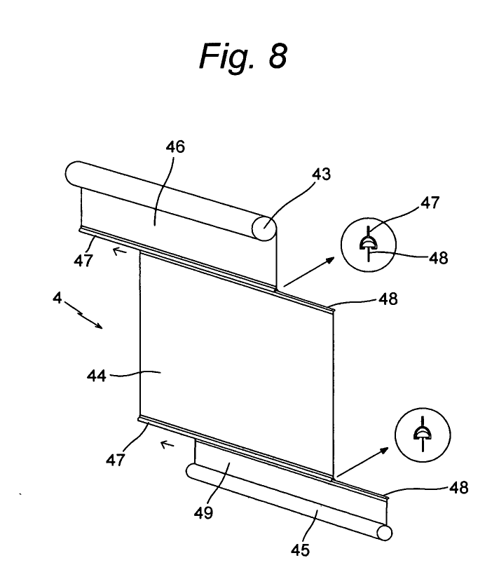

FIG. 7 and FIG. 8 show a third preferred embodiment of the display device of the invention, and it is similar to the second preferred embodiment except that engaging rail member to be engaged by inserting convex protrusions into concave grooves is used for junction between the display sheet and the adjusting sheet.

A display device 4 has a display sheet 44 showing printed advertising or decorating display object rolled on a roll 43, and display object is formed by unrolling and stretching by the roll 43, and the roll 43 is provided with an adjusting sheet 46 for taking up and letting off freely according to a desired length. At the lower end edge of the adjusting sheet 46, a first engaging rail member 47 of a semicircular section and having concave grooves 472 for forming slits 471 in the center of lower side is disposed, and at the edge opposite to the adjusting sheet 46 fixed to the roll 43 on the display sheet 44, a second engaging rail member 48 having convex protrusions 481 of a semicircular section of width and diameter to be inserted in the concave grooves 472 is disposed.

The support member 45 for other part of the display sheet is a cylindrical bar long in the axial direction, and an adjusting sheet 49 formed of a sheet member fixed in its axial direction, and at the edge opposite to the display sheet 44, a second engaging rail member 48 having convex protrusions 481 of a semicircular section is disposed, and at the end opposite to the adjusting sheet 49 fixed to the support member 45 for other part of the display sheet, a first engaging rail member 47 of a semicircular section and having concave grooves 472 for forming slits 471 in the center of lower side is disposed.

When exchanging the display sheet 44, by rotating the roll 43, the adjusting sheet 46 is lowered nearly to the floor. In this state, the second engaging rail member 48 of the existing display sheet 44 is drawn out, that is, pulled in the axial direction to be removed from the concave grooves 472 of the first engaging roll member 47, so that the display sheet 44 may be easily removed from adjusting sheet 467 fixed to the roll, and by pulling the engaging rail member 48 of the adjusting sheet 46 fixed to the support member 45 for other part of the display sheet in the axial direction to be drawn out from the concave grooves 472 of the first engaging rail member 47 at the lower end of the display sheet 44, the display sheet 44 can be easily detached from the adjusting sheet 49 fixed to the support member 45 for other part of the display sheet.

Further, when presenting a new display sheet 44, the adjusting sheet 46 is brought closer to the person exchanging the display sheet, and the protrusion 481 of the second engaging rail member 48 at the upper edge of a new display sheet 44 is inserted and engaged into the concave groove 472 of the first engaging rail member 472 at the lower edge of the display sheet 44, and the protrusion 481 of the engaging rail member 48 of the adjusting sheet 49 fixed to the support member 45 for other part of the display sheet is inserted and engaged in the concave groove 472 of the first engaging rail member at the lower edge of the display sheet 44, and the adjusting sheet 46 is taken upon the roll 43, and then the display sheet 44 can be stretched.

Further, in the display devices 1 to 3 in the preferred embodiments, the display sheet is not particularly specified as far as it is the sheet member to be taken up on the roll, but when installed outdoor, a mesh sheet allowing passing of wind is preferred, and a lightweight non-woven cloth is preferred when installed outdoors. The advertising and decorating display object may be applied either on one side or both sides of the display sheet.

Further, in the display devices 1 to 3 in the preferred embodiments, the support member for other part of the display sheet for supporting stretching of the display sheet is provided, but it may not be always needed as far as the display sheet can be stretched by own weight or by a stopper structure disposed on the rotary shaft.

Further, the display devices 1 to 3 are disposed so that the display sheet may droop down from the roll, but the display sheet may be disposed to be stretched in the horizontal direction.

According to the display device of the present invention, in the display device for forming the display object by letting off and stretching the display sheet having the advertising and decorating display object taken up on the roll, one part of the display sheet is fixed detachably on the roll, and the display sheet can be easily mounted without dismounting the roll from the place of installation. Therefore, the display can be easily exchanged, and it is not required to exchange the display sheet in every roll, and the running cost may be saved.

Further, in the display device for forming the display object by letting off and stretching the display sheet having the advertising and decorating display object taken up on the roll, the roll is provided with an adjusting sheet capable of taking up and letting off freely depending on a desired length, and one part of the display sheet is freely attached or detached to and from the adjusting sheet provided on the roll, and the take-up amount of the adjusting sheet is adjusted, and the display sheet may be presented at desired position and height depending on the size of the display sheet, and, for example, in the case of a large display sheet such as the display on the window of an automobile sales shop, the display sheet can be attached and detached easily and safely by bringing the adjusting sheet closer to the hand of the handling person from the roll, and the display sheet can be exchanged easily and safely without requiring stepladder or the like.

The other part of the display sheet being left off is stopped detachably to and from to the support member for other part of the display sheet, and the display sheet may be easily attached or detached to and from the support member for other part of the display sheet for stretching and supporting the display sheet. Therefore, the display object may be exchanged easily, and the display sheet is not exchanged together with the support member for other part of the display sheet, and the running cost is lower. Only the display sheet is removed, the display sheet after removal may be stored in a state wound on paper tube or in a plaited state.

The other part of the display sheet being let off is freely attached to or detached from the adjusting sheet provided on the support member for other part of the display sheet, and hence it is possible to fix freely by attaching to or detaching from the cylindrical other part support member not having flat surface, for example. Further, the display sheet can be fixed to support member for other part of the display sheet easily by way of the adjusting sheet. Therefore, the display object can be exchanged easily. It is not required to exchange the display sheet in every support member for other part of the display sheet, and the running cost is saved, and since only the display sheet is removed, the display sheet after removal may be stored in a state wound on paper tube or in a plaited state.

One part of the display sheet and the roll, other part of the display sheet and support member for other part of the display sheet, and means for detachably fixing the display sheet and adjusting sheet are means for fixing detachably, and the display sheet can be easily attached or detached without dismounting the roll from the place of installation. Therefore, the display sheet may be exchanged easily, and the display sheet is not exchanged together with the roll, and the running cost is saved.

One part of the display sheet and the roll, other part of the display sheet and support member for other part of the display sheet, and means for detachably fixing the display sheet and adjusting sheet are surface fasteners respectively mounted and formed, and only by abutting and adhering the surface fasteners, the display sheet can be mounted, and only by peeling the surface fasteners, the display sheet can be dismounted, and the display sheet can be exchanged easily. Also by the adhesive force of the surface fastener strong in force in a direction horizontal to the plane, the display sheet is not peeled and dropped off.

One part of the display sheet and the roll, other part of the display sheet and support member for other part of the display sheet, and means for detachably fixing the display sheet and adjusting sheet are engaging rail members for engaging being provided with a pair of concave groove and convex protrusion, and the adjusting sheet and display sheet are reinforced by engaging rail member, and a flat appearance is maintained without being deflected or distorted, and the display sheet can be attached or detached easily only by engaging or disengaging the concave groove and convex protrusion of the engaging rail member, so that the display sheet may be exchanged easily.

When the display sheet is formed of a mesh member having numerous fine pores, when installed outdoors, fluttering by wind can be prevented. When the display sheet is formed of a lightweight non-woven cloth, even in a case of a large display sheet, without applying load to the roll, the display object can be displayed safely.

1. A display device having a display sheet showing printed advertising or decorating display object rolled on a roll, for forming a display object by unrolling and stretching by the roll, wherein one part of the display sheet is detachably attached to the roll.

2. A display device having a display sheet showing printed advertising or decorating display object rolled on a roll, for forming a display object by unrolling and stretching by the roll, wherein the roll is provided with an adjusting sheet capable of taking up and letting off freely depending on a desired length, and one part of the display sheet is detachably attached to the adjusting sheet provided on the roll.

3. The display device according to claim 1,
wherein other part of the unrolled display sheet is detachably attached to a support member for other part of the display sheet.

4. The display device according to claim 1,
wherein other part of the unrolled display sheet is detachably attached to an adjusting sheet provided on a support member for other part of the display sheet.

5. The display device according to claim 14,
wherein means for attaching and detaching one part of the display sheet and the roll, other part of the display sheet and the support member for other part of the display sheet, and the display sheet and the adjusting sheet is fixing means for adhering and stripping freely.

6. The display device according to claim 1,
wherein means for attaching and detaching one part of the display sheet and the roll, other part of the display sheet and the support member for other part of the display sheet, and the display sheet and the adjusting sheet is a surface fastener formed on each surface.

7. The display device according to claim 1,
wherein means for attaching and detaching one part of the display sheet and the roll, other part of the display sheet and the support member for other part of the display sheet, and the display sheet and the adjusting sheet is an engaging rail member provided in each pair of concave groove and convex protrusion for engaging with each other.

8. The display device according to claim 1,
wherein the display sheet is a mesh cloth having numerous fine pores or a lightweight non-woven cloth.

9. The display device according to claim 2,
wherein other part of the unrolled display sheet is detachably attached to a support member for other part of the display sheet.

10. The display device according to claim 2,
wherein other part of the unrolled display sheet is detachably attached to an adjusting sheet provided on a support member for other part of the display sheet.

11. The display device according to claim 3,
wherein other part of the unrolled display sheet is detachably attached to an adjusting sheet provided on a support member for other part of the display sheet.

12. The display device according to claim 2,
wherein means for attaching and detaching one part of the display sheet and the roll, other part of the display sheet and the support member for other part of the display sheet, and the display sheet and the adjusting sheet is fixing means for adhering and stripping freely.

13. The display device according to claim 3,
wherein means for attaching and detaching one part of the display sheet and the roll, other part of the display sheet and the support member for other part of the display sheet, and the display sheet and the adjusting sheet is fixing means for adhering and stripping freely.

14. The display device according to claim 4,
wherein means for attaching and detaching one part of the display sheet and the roll, other part of the display sheet and the support member for other part of the display sheet, and the display sheet and the adjusting sheet is fixing means for adhering and stripping freely.

15. The display device according to claim 2,
wherein means for attaching and detaching one part of the display sheet and the roll, other part of the display sheet and the support member for other part of the display sheet, and the display sheet and the adjusting sheet is a surface fastener formed on each surface.

16. The display device according to claim 3,
wherein means for attaching and detaching one part of the display sheet and the roll, other part of the display sheet and the support member for other part of the display sheet, and the display sheet and the adjusting sheet is a surface fastener formed on each surface.

17. The display device according to claim 4,
wherein means for attaching and detaching one part of the display sheet and the roll, other part of the display sheet and the support member for other part of the display sheet, and the display sheet and the adjusting sheet is a surface fastener formed on each surface.

18. The display device according to claim 5,
wherein means for attaching and detaching one part of the display sheet and the roll, other part of the display sheet and the support member for other part of the display sheet, and the display sheet and the adjusting sheet is a surface fastener formed on each surface.

19. The display device according to claim 2,
wherein means for attaching and detaching one part of the display sheet and the roll, other part of the display sheet and the support member for other part of the display sheet, and the display sheet and the adjusting sheet is an engaging rail member provided in each pair of concave groove and convex protrusion for engaging with each other.

20. The display device according to claim 3,
wherein means for attaching and detaching one part of the display sheet and the roll, other part of the display sheet and the support member for other part of the display sheet, and the display sheet and the adjusting sheet is an engaging rail member provided in each pair of concave groove and convex protrusion for engaging with each other.
